(19) United States
(12) Patent Application Publication
(10) Pub. No.: US 2018/0037782 A1
(43) Pub. Date: Feb. 8, 2018

(54) PRESSURE SENSITIVE ADHESIVE AND LAMINATE

(71) Applicant: 3M INNOVATIVE PROPERTIES COMPANY, St. Paul, MN (US)

(72) Inventor: Kotaro Shinozaki, Yokohama (JP)

(21) Appl. No.: 15/550,384

(22) PCT Filed: Mar. 3, 2016
(86) PCT No.: PCT/US2016/020536

§ 371 Date: Aug. 11, 2017

(30) Foreign Application Priority Data
Mar. 6, 2015 (JP) 2015-044903

(51) Int. Cl. C09J 133/08; C09J 7/02

(52) U.S. Cl. CPC C09J 133/08; C09J 7/0217; C08K 3/36

(57) ABSTRACT

A pressure sensitive adhesive containing an adhesive polymer having, as a monomer unit, a monomer having (A) a (meth) acrylic acid ester represented by Formula (1) shown below, (B) a (meth) acrylic acid, and (C) a monomer having a nitrogen atom and a vinyl group, and a hydrophobic silica microparticle, where component (A) contains 50 parts or more by weight of the (meth) acrylic acid ester, where R² in Formula (1) shown below is an alkyl group having 4 to 6 carbon atoms, for every 100 parts by weight of component (A). (In Formula (1), R¹ represents a hydrogen atom or a methyl group, and R² represents alkyl group.)

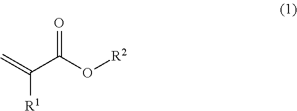

### BACKGROUND

### Technical Field

The present invention relates to pressure sensitive adhesives and laminates that include such an adhesive.

### Background

When adhering vehicle exterior parts, such as when attaching a visor (side visor or door visor) to a door of a vehicle, for example, a pressure sensitive adhesive is used. For example, Japanese Unexamined Patent Application Publication No. 2012-117016 discloses an adhesive used in a vehicle exterior part such a visor, and the like.

### SUMMARY

In recent years, polyvinyl chloride is sometimes used as a material for configuring vehicle exterior parts, and thus a pressure sensitive adhesive must adhere well to polyvinyl chloride. Furthermore, because a variety of external forces will be applied to the parts in a wide range of environments ranging from low temperatures to high temperatures after the parts are attached, the pressure sensitive adhesive must adhere well against a variety of external forces in a wide range of environments.

The present invention provides, as one aspect thereof, a pressure sensitive adhesive containing an adhesive polymer having, as a monomer unit, a monomer having (A) a (meth) acrylic acid ester represented by Formula (1) shown below, (B) a (meth) acrylic acid, and (C) a monomer having a nitrogen atom and a vinyl group, and a hydrophobic silica microparticle, where component (A) contains 50 parts or more by mass of the (meth) acrylic acid ester, where R² in Formula (1) shown below is an alkyl group having 4 to 6 carbon atoms, for every 100 parts by mass of component (A).

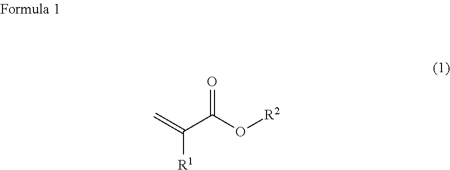

(In Formula (1), R¹ represents a hydrogen atom or a methyl group, and R² represents an alkyl group.)

According to the present invention, a pressure sensitive adhesive can be provided that displays good adhesion (especially in terms of allowable opening) relative to a variety of external forces in a range of environments, and preferably in a wide range of environments, even when polyvinyl chloride is used as an adherend.

### BRIEF DESCRIPTION OF THE DRAWINGS

FIG. 1 is a cross sectional view illustrating an embodiment of a laminate.

FIG. 2 is a schematic view illustrating a procedure for an allowable opening test.

FIG. 3 is a schematic view illustrating a procedure following that of FIG. 2.

### DETAILED DESCRIPTION

The pressure sensitive adhesive according to the present embodiment contains an adhesive polymer and a hydrophobic silica microparticle. Here, “pressure sensitive adhesive” indicates an adhesive that displays adhesion at an application temperature (typically −20° C. to 60° C.), and “adhesion” means that a storage modulus of elasticity (G′), measured at 10 radians per second at an application temperature (preferably measured at from 20° C. to 22° C.), is less than 3×10⁵ pascals (Dahlquist Criterion). “Adhesive polymer” means a polymer having the “adhesion” described above, and the term “polymer” adheres to the definition of a “macromolecule” or “polymer” in accordance with the Polymer Nomenclature Commission of the International Union of Pure and Applied Chemistry (IUPAC) (http://main.spsj.or.jp/cl9/iupac/Recommendations/glossary36.html).

The adhesive polymer has components (A), (B), and (C) described below as monomer units. (A) is a (meth) acrylic acid ester represented by Formula (1) shown below,

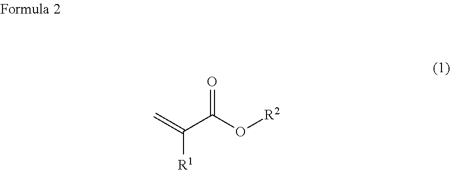

(In Formula (1), R¹ represents a hydrogen atom or a methyl group, and R² represents an alkyl group.)

(B) is a (meth) acrylic acid, and
(C) is a monomer having a nitrogen atom and a vinyl group.
Note that “(meth) acrylic” means an acrylic or methacrylic (also sometimes expressed as methacrylic), and is synonymous with similar compounds.

Component (A) contains a (meth) acrylic acid ester (also referred to as a “first (meth) acrylic acid ester”) where R² in Formula (1) is an alkyl group having 4 to 6 carbon atoms. Examples of suitable first (meth) acrylic acid esters include n-butyl (meth) acrylate, isobutyl (meth) acrylate, n-pentyl acrylate, isopentyl acrylate, n-hexyl acrylate, and isohexyl acrylate.

From the perspective of superior allowable opening, a contained amount of the first (meth) acrylic acid ester is preferably 50 or more parts by mass, more preferably 55 or more parts by mass, and even more preferably 60 or more parts by mass for every 100 parts by mass of component (A). The contained amount of the first (meth) acrylic acid ester may be, for example, 90 or fewer parts by mass for every 100 parts by mass of component (A). Note that “parts by mass” is sometimes expressed as “parts by weight” and that “parts by mass” and “parts by weight” are synonymous.

From the perspective of superior allowable opening, component (A) also preferably contains a (meth) acrylic acid ester (also referred to as a “second (meth) acrylic acid ester”) where R² in Formula (1) is an alkyl group having 8 to 10 carbon atoms. Examples of suitable second (meth) acrylic acid esters include n-octyl (meth) acrylate, isooctyl (meth) acrylate, 2-ethyl hexyl (meth) acrylate, isononyl (meth) acrylate, n-decyl (meth) acrylate, and mixtures of these.

From the perspective of superior allowable opening, a contained amount of the second (meth) acrylic acid ester is preferably 50 or fewer parts by mass, more preferably 45 or fewer parts by mass, and even more preferably 40 or fewer parts by mass for every 100 parts by mass of component (A). The contained amount of the second (meth) acrylic acid ester may be, for example, 10 or more parts by mass for every 100 parts by mass of component (A).

A contained amount of component (A) may be, for example, 70 or more parts by mass, 73 or more parts by mass, 76 or more parts by mass, 80 or more parts by mass, or 85 or more parts by mass, or, may be, for example, 90 or fewer parts by mass for every 100 parts by mass of a total mass of component (A), component (B), and component (C).

From the perspective of superior adhesion at low temperatures (for example, 10° C. or lower), in addition to superior allowable opening, a contained amount of component (B) is preferably 10 or fewer parts by mass, more preferably 7 parts by mass, even more preferably 5 or fewer parts by mass, and particularly preferably 4 or fewer parts by mass for every 100 parts by mass of the total mass of component (A), component (B), and component (C). The contained amount of component (B) may be, for example, 1 or more parts by mass, 2 or more parts by mass, or 3 or more parts by mass for every 100 parts by mass of the total mass of component (A), component (B), and component (C).

Component (C) has a nitrogen atom and a vinyl group, and may be any monomer that is copolymerizable with component (A) and component (B). More specifically, component (C) may be a monomer having an amide group, an amino group, a functional group including a nitrogen atom, such as a nitrogen containing heterocyclic group, and the like, and a vinyl group. Examples of such a monomer include N-vinylpyrrolidone, N-vinylcaprolactone, (meth) acryloylmorpholine, (meth) acrylamide, N,N-dimethyl (meth) acrylamide, N,N-diethyl (meth) acrylamide, N,N-dimethylaminoethyl (meth) acrylate, N,N-diethylaminoethyl (meth) acrylate, N,N-dimethylaminopropyl (meth) acrylamide, (meth) acrylonitrile, mixtures of these, and the like.

From the perspective of superior adhesion at low temperatures (for example, 10° C. or lower), in addition to superior allowable opening, a contained amount of component (C) is preferably 20 or fewer parts by mass, more preferably 17 parts by mass, even more preferably 15 or fewer parts by mass, and particularly preferably 12 or fewer parts by mass for every 100 parts by mass of the total mass of component (A), component (B), and component (C). The contained amount of component (C) may be, for example, 5 or more parts by mass, 8 or more parts by mass, or 11 or more parts by mass for every 100 parts by mass of the total mass of component (A), component (B), and component (C).

The adhesive polymer is obtained by photopolymerizing or thermal polymerizing component (A), component (B), and component (C) using a polymerization initiator and a cross linking agent, and the like, as needed. Examples of a cross linking agent include 1,6-hexanediol di (meth) acrylate, trimethylolpropane tri (meth) acrylate, pentaerythritol tetra (meth) acrylate, 1,2-ethylene glycol di (meth) acrylate, urethane di (meth) acrylate, urethane tri (meth) acrylate, mixtures of these, and the like. Examples of a photopolymerization initiator include benzoin alkyl ether, acetophenone, benzophenone, benzyl methyl ketal, hydroxycyclohexyl phenyl ketone, 1,1-dichloro-acetophenone, 2-chloro-thioxanthone, and the like, and, for example, Irgacure651 (2,2-dimethoxy-1,2-diphenyl-ethane-1-one) can be purchased from Ciba Specialty Chemicals, Inc. and Darocur 1173, and the like, can be purchased from Merck Japan. Examples of a thermal polymerization initiator include an azo-based polymerization initiator (for example, 2,2′-azobisisobutyronitrile, and the like), a peroxide-based polymerization initiator (for example, dibenzoyl peroxide, t-butyl hydro peroxide, and the like), a redox polymerization initiator, and the like.

The hydrophobic silica microparticle is, for example, a solid microparticle. The hydrophobic silica microparticle may be formed using molten silica. A particle diameter (average diameter of primary particles) of the hydrophobic silica microparticle may be, for example, 1 to 500 nm.

For example, AEROSIL R972, AEROSIL R974, AEROSIL R976, AEROSIL R104, AEROSIL R106, AEROSIL R202, AEROSIL R805, AEROSIL R812, AEROSIL R812S, AEROSIL R816, AEROSIL R7200, AEROSIL R8200, AEROSIL R9200, and the like, can be purchased from Japan Aerosil, Inc., DM10, and the like, can be purchased from Tokuyama Corporation, and Sylophobic 200, Sylophobic 704, Sylophobic 505, Sylophobic 603, and the like, can be purchased from Fuji Silysia Chemical, Ltd.

From the perspective of superior long term stability, as well as allowable opening, a contained amount of the hydrophobic silica microparticles is preferably 6 or fewer parts by mass, more preferably 5 or fewer parts by mass, and particularly preferably 4 or fewer parts by mass for every 100 parts by mass of the adhesive polymer. The contained amount of the hydrophobic silica microparticles may be, for example, 1 or more parts by mass, 2 or more parts by mass, or 3 or more parts by mass for every 100 parts by mass of the adhesive polymer.

In addition to the components described above, the pressure sensitive adhesive may also contain well-known additives used in pressure sensitive adhesives, such as polymerization initiators, cross linking agents, plasticizers, fillers, anti-aging agents, ultraviolet light absorbers, dyes, and the like.

For example, a tape shaped pressure sensitive adhesive tape may be used as the pressure sensitive adhesive. In this case, for example, a liner may be provided on one side of the pressure sensitive adhesive tape.

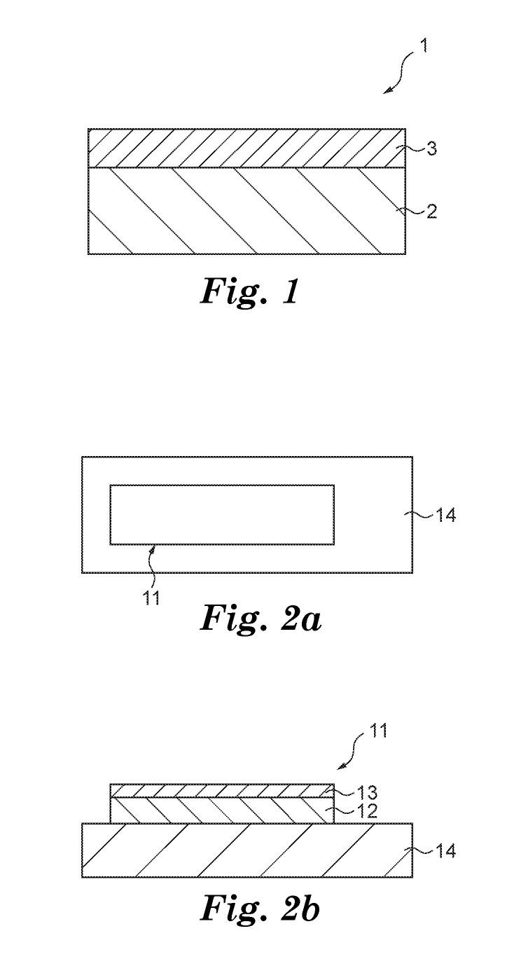

A laminate of the pressure sensitive adhesive tape, and the like, may be used as the pressure sensitive adhesive by laminating the tape on a base material layer. FIG. 1 is a cross sectional view illustrating an embodiment of the laminate. As is illustrated in FIG. 1, a laminate 1, a base material layer 2, and a pressure sensitive adhesive layer 3 provided on a main surface of the base material layer 2, are provided.

The base material layer 2 may be, for example, a film, a sheet made of foam material, a nonwoven fabric, and the like. The film may be, for example, a polyethylene film, a polypropylene film, a polyester film, a polycarbonate film, a polyvinyl chloride film, a polyvinylidene chloride film, a polystyrene film, a polyamide film, and the like. The sheet made of foam material may be, for example, an acrylic foam sheet, a polyethylene foam sheet, a chloroprene foam sheet, a urethane foam sheet, and the like.

The sheet made of foam material itself may be a sheet having adhesion. An acrylic foam tape (RT8016 manufactured by 3M Japan, Inc.), and the like, can be purchased as such a sheet. The nonwoven fabric may be a nonwoven fabric formed from a polyester, such as polyethylene terephthalate (PET), and the like, a polyolefin, such as high-density polyethylene, polypropylene, and the like, nylon, polyvinyl alcohol, polyacrylonitrile, a cellulose-based natural pulp fiber, such as cotton, hemp, and the like, a heat-resistant fiber, such as rayon, heat-resistant synthetic fiber, polyamide fiber, glass fiber, and the like. A thickness of the base material layer 2 may be, for example, either 50 μm to 4 mm or 500 μm to 3 mm.

The pressure sensitive adhesive layer 3 is made from, for example, the pressure sensitive adhesive described above. A thickness of the pressure sensitive adhesive layer 3 may be, for example, either 10 m to 1 mm or 50 m to 500 μm.

The laminate may also be provided with a liner, a primer layer, and the like. The liner may be provided, for example, either on a surface of the base material layer side or a surface of the pressure sensitive adhesive layer side. The primer layer may be provided, for example, between the base material layer and the pressure sensitive adhesive layer. The laminate may provide the pressure sensitive adhesive layer on both sides of the base material layer. In this case, the laminate can be used as double sided pressure sensitive adhesive tape.

The pressure sensitive adhesive and the laminate described above can be suitably used to adhere products used under a variety of conditions, such as vehicle parts, construction materials, electronic components, office equipment, and the like, and can be used particularly suitably to adhere adherends formed using polyvinyl chloride.

### Examples

Hereinafter, the present invention will be described more specifically based on examples, but the present invention is not intended to be limited by the following examples.

### Production of a Pressure Sensitive Adhesive

Pressure sensitive adhesives having the compositions shown in Tables 1 through 3 were produced using the materials shown below. Note that the numbers in parentheses for component (A) show the parts by mass of each component for every 100 parts by mass of component (A).

nBA: n-butyl acrylate (Nippon Shokubai Co., Ltd.)
2EHA: 2-ethylhexyl acrylate (Nippon Shokubai Co., Ltd.)
AA: Acrylic acid (Mitsubishi Gas Chemical Co., Ltd.)
DMAA: N,N-dimethyl acrylamide (Kohjin Film & Chemicals Co., Ltd.)
R972: Hydrophobic silica microparticles (Japan Aerosil, Inc.)
Irgacure651: Photopolymerization initiator (Ciba Specialty Chemicals, Inc.)
HDDMA: 1,6-hexane diol dimethacrylate (Kyoeisha Chemical Co., Ltd.)

Specifically, the nBA, 2EHA, DMAA, HDDMA, and a portion of the Irgacure651 (the amounts disclosed in the Irgacure (1) rows of Tables 1 and 2) were mixed first. The obtained mixture was irradiated with 0.5 mW/cm² of ultraviolet light, and the irradiation was ended at the point when the viscosity of the mixture reached 1000 cps. After irradiation by ultraviolet light, the AA, the remainder of the Irgacure651 (the amounts disclosed in the Irgacure (2) rows of Tables 1 and 2), and the R972 were added to the mixture, and the mixture was stirred and then cooled to 23° C. to obtain a pressure sensitive adhesive. The obtained pressure sensitive adhesive was applied to a clear PET film, and then another PET film was placed on the applied pressure sensitive adhesive. The thickness of the sheet shaped pressure sensitive adhesive was 0.10 mm. The sheet shaped pressure sensitive adhesive was then irradiated with 0.5 mW/cm² (total energy: 1J) of ultraviolet light to thus obtain a pressure sensitive adhesive sheet placed between two PET films. Next, one of the PET films was peeled off and the pressure sensitive adhesive sheet was then laminated to one side of a 1.6 mm thick piece of 3M™ acrylic foam tape (RT8016, 3M Japan, Inc.) to thus obtain a 1.7 mm thick laminate.

The allowable opening test described below was performed on the laminate obtained as described above. The results are shown on Tables 1 and 2.

### Allowable Opening Test

(1) A laminate 11 of an acrylic foam tape 12 and a pressure sensitive adhesive sheet 13 was cut into a rectangle measuring 10 mm×50 mm and then placed on a stainless steel plate 14 (FIGS. 2 (a) and (b)).

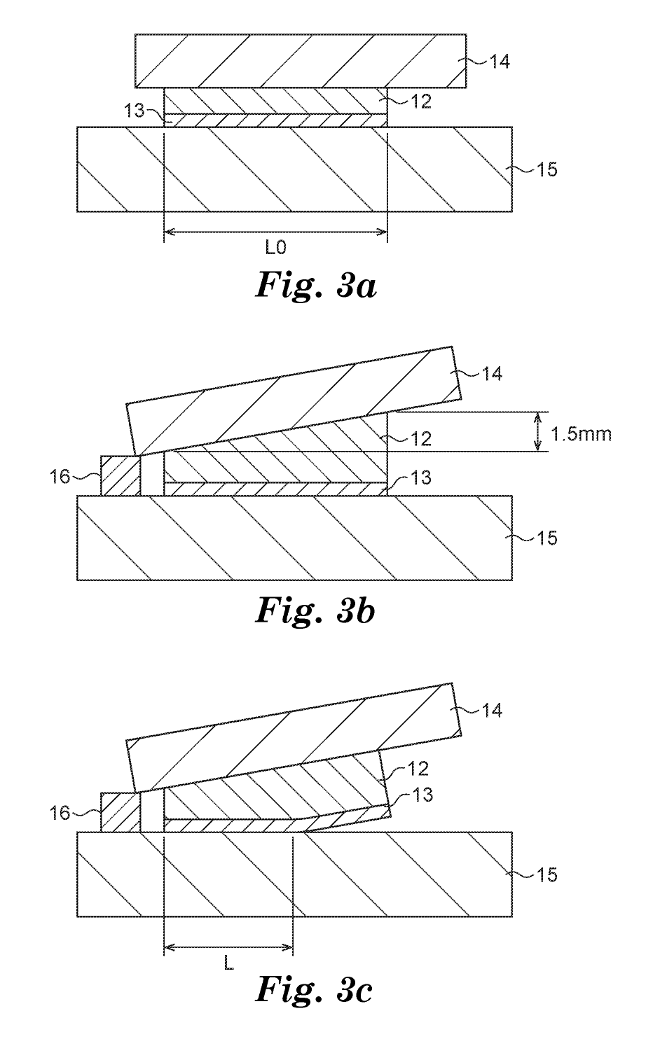

(2) A test piece 15 configured of the stainless steel plate and a soft polyvinyl chloride layer bonded with adequate strength to the surface of the stainless steel plate was prepared. The surface of the test piece 15 was washed with white gasoline, and the sample from (1) described above was placed so that the pressure sensitive adhesive sheet 13 adhered to the test piece 15 (FIG. 3 (a)). Note that a length in the longitudinal direction of a bonded portion between the pressure sensitive adhesive sheet 13 and the test piece 15, at this time, was designated L0.

(3) The sample from (2) described above was allowed to sit for 24 hours, one end of the stainless steel plate 14 was secured using a spacer 16, and then the other end of the stainless steel plate 14 was separated from the test piece 15 and secured (FIG. 3 (b)). The size of an opening (the length in the vertical direction from one end to the other end of the bonded portion between the acrylic foam tape 12 and the stainless steel plate 14), at this time, was 1.5 mm.

(4) The sample from (3) described above was stored for 100 hours in 40° C. warm water, and then the sample was observed (FIG. 3 (c)). A length in the longitudinal direction of a bonded portion between the pressure sensitive adhesive sheet 13 and the test piece 15, at this time, was designated L. The evaluation of the allowable opening was designated as “A” when L/L0 was 0.6 or more, as “B” when 0.4 or more but less than 0.6, and as “C” when less than 0.4.

TABLE 1

| | | | Exam- | Exam- | Exam- | Exam- |
|---|---|---|---|---|---|---|
| | | | ple 1 | ple 2 | ple 3 | ple 4 |
| Compo- | component | nBA | 82(100) | 63(77) | 50(61) | 51(60) |
| sition | (A) | 2HA | —(—) | 19(23) | 32(39) | 34(40) |
| (parts | component | AA | 3 | 3 | 3 | 3 |
| by | (B) | | | | | |
| mass) | component | DMAA | 15 | 15 | 15 | 12 |
| | (C) | | | | | |

| | | | | |
|---|---|---|---|---|
| R972 | 4 | 4 | 4 | 4 |
| Irgacure651 (1) | 0.04 | 0.04 | 0.04 | 0.04 |
| Irgacure651 (2) | 0.2 | 0.2 | 0.2 | 0.2 |
| HDDMA | 0.04 | 0.04 | 0.04 | 0.04 |

| | | | | |
|---|---|---|---|---|
| Allowable opening test | A | A | A | A |

TABLE 2

| | | | Exam- | Exam- | Exam- | Exam- |
|---|---|---|---|---|---|---|
| | | | ple 5 | ple 6 | ple 7 | ple 8 |
| Compo- | component | nBA | 50(61) | 48(62) | 46(61) | 45(62.5) |
| sition | (A) | 2HA | 32(39) | 30(38) | 29(39) | 27(37.5) |
| (parts | component | AA | 3 | 7 | 10 | 3 |
| by | (B) | | | | | |
| mass) | component | DMAA | 15 | 15 | 15 | 25 |
| | (C) | | | | | |

| | | | | |
|---|---|---|---|---|
| R972 | 8 | 4 | 4 | 4 |
| Irgacure651 (1) | 0.04 | 0.04 | 0.04 | 0.04 |
| Irgacure651 (2) | 0.2 | 0.2 | 0.2 | 0.2 |
| HDDMA | 0.04 | 0.04 | 0.04 | 0.04 |

| | | | | |
|---|---|---|---|---|
| Allowable opening test | A | A | A | A |

TABLE 3

| | | | Comparative | Comparative | Comparative | Comparative | Comparative |
|---|---|---|---|---|---|---|---|
| | | | Example 1 | Example 2 | Example 3 | Example 4 | Example 5 |
| Compo- | component | nBA | —(—) | 50(61) | 32(39) | 51(60) | 57(59) |
| sition | (A) | 2HA | 82(100) | 32(39) | 50(61) | 34(40) | 40(41) |
| (parts | component | AA | 3 | 3 | 3 | — | 3 |
| by | (B) | | | | | | |
| mass) | component | DMAA | 15 | 15 | 15 | 15 | — |
| | (C) | | | | | | |

| | | | | | |
|---|---|---|---|---|---|
| R972 | 4 | — | 4 | 4 | 4 |
| Irgacure651 (1) | 0.04 | 0.04 | 0.04 | 0.04 | 0.04 |
| Irgacure651 (2) | 0.2 | 0.2 | 0.2 | 0.2 | 0.2 |
| HDDMA | 0.04 | 0.04 | 0.04 | 0.04 | 0.04 |

| | | | | | |
|---|---|---|---|---|---|
| Allowable opening test | C | C | B | C | C |

High temperature peel strength, low temperature adhesion, and long term stability, as described below, were also evaluated for the laminates obtained as described above. The results are shown in Tables 4 through 6.

### High Temperature Peel Strength

(1) A laminate was cut into a rectangle measuring 10 mm×80 mm and then a 50 m PET film to which a primer (3M, Inc., Product name: N200) had been applied was laminated on an acrylic foam tape side of the laminate.

(2) A test piece configured of a stainless steel plate and a soft polyvinyl chloride layer bonded with adequate strength to the surface of the stainless steel plate was prepared. The surface of the test piece was washed with white gasoline, and the sample from (1) described above was placed so that a pressure sensitive adhesive sheet adhered to the test piece.

(3) The sample from (2) described above was allowed to sit for 24 hours and was then stored at 80° C. for one hour.

(4) A pulling force of 50 mm/min was applied in a 180° direction (a direction parallel to a bonding surface between the pressure sensitive adhesive sheet and the test piece) to the sample after storage and peel strength at that time was measured.

### Low Temperature Adhesion

(1) A laminate was cut into a rectangle measuring 10 mm×80 mm and then a 50 m PET film to which a primer (3M, Inc., Product name: N200) had been applied was laminated on an acrylic foam tape side of the laminate.

(2) The sample from (1) described above and an SUS304BA, which is a laminate, were stored at 5° C. for one hour.

(3) After storage, the SUS304BA was washed in isopropyl alcohol, and then the sample, also after storage, was placed on the SUS304BA so that a pressure sensitive adhesive sheet adhered to the SUS304BA.

(4) Within 30 seconds thereafter, a pulling force of 300 mm/min was then applied in a 90° direction (the vertical direction in the bonding surface between the pressure sensitive adhesive sheet and the SUS304BA) to the sample from (3) described above, and an adhesion strength at that time was measured.

### Long Term Stability

(1) A laminate that had been stored for two weeks at 80° C. was restored to room temperature, and then the laminate was cut into a rectangle measuring 10 mm×80 mm and a 50 m PET film to which a primer (3M, Inc., Product name: N200) had been applied was laminated on an acrylic foam tape side of the laminate.

(2) The sample from (1) described above and an SUS304BA, which is a laminate, were stored at 5° C. for one hour.

(3) After storage, the SUS304BA was washed in isopropyl alcohol, and then the sample, also after storage, was placed on the SUS304BA so that a pressure sensitive adhesive sheet adhered to the SUS304BA.

(4) Subsequently, within 30 seconds thereafter, a pulling force of 300 mm/min was applied in a 90° direction (the vertical direction in the bonding surface between the pressure sensitive adhesive sheet and the SUS304BA), to the sample from (3) described above, and an adhesion strength I at that time was measured.

(5) A decline rate (I/I0×100(%)) relative to an adhesion strength I0 measured in (low temperature adhesion strength) described above was calculated.

TABLE 4

| | Example 1 | Example 2 | Example 3 | Example 4 |
|---|---|---|---|---|
| High temperature peel | 9.5 | 10.0 | 10.1 | 10.4 |
| strength (N/cm) | | | | |
| Low temperature | 17.8 | 19.2 | 19.0 | 21.3 |
| adhesion (N/cm) | | | | |
| Long term stability (%) | 90 | 90 | 90 | 92 |

TABLE 5

| | Example 5 | Example 6 | Example 7 | Example 8 |
|---|---|---|---|---|
| High temperature peel | 9.7 | 9.7 | 9.9 | 12.7 |
| strength (N/cm) | | | | |
| Low temperature | 14.5 | 5.8 | 2.3 | 6.8 |
| adhesion (N/cm) | | | | |
| Long term stability (%) | 54 | 90 | 100 | 96 |

TABLE 6

| | Compar- | Compar- | Compar- | Compar- | Compar- |
|---|---|---|---|---|---|
| | ative | ative | ative | ative | ative |
| | Exam- | Exam- | Exam- | Exam- | Exam- |
| | ple 1 | ple 2 | ple 3 | ple 4 | ple 5 |
| High temper- | 10.4 | 8.2 | 10.2 | 5.6 | 0.7 |
| ature peel | | | | | |
| strength | | | | | |
| (N/cm) | | | | | |
| Low temper- | 16.5 | 18.8 | 19.7 | 19.7 | 12.9 |
| ature adhe- | | | | | |
| sion (N/cm) | | | | | |
| Long term | 91 | 96 | 91 | 91 | 90 |
| stability (%) | | | | | |

1.-6. (canceled)

7. A pressure sensitive adhesive comprising:
I) an adhesive polymer comprising as monomer units:
(A) 70 wt % or greater (meth)acrylic acid esters according to Formula (1): 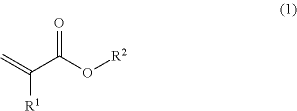
wherein R¹ is a hydrogen atom or a methyl group and R² is an alkyl group;
(B) 1-10 wt % (meth)acrylic acid; and
(C) 5-20 wt % monomers comprising a nitrogen atom and a vinyl group; and
II) 1-6 parts by mass for every 100 parts by mass of the adhesive polymer of a hydrophobic silica microparticle;
wherein component (A) comprises 50 wt % or more of (meth)acrylic acid esters wherein R² is an alkyl group having 4 to 6 carbon atoms.

8. The pressure sensitive adhesive according to claim 1, wherein component (A) additionally comprises 10-50 wt % (meth)acrylic acid esters wherein R² is an alkyl group having 8 to 10 carbon atoms.

9. A laminate, comprising:
a base material layer; and
a pressure sensitive adhesive layer made from the pressure sensitive adhesive according to claim 1.

10. A laminate, comprising:
a base material layer; and
a pressure sensitive adhesive layer made from the pressure sensitive adhesive according to claim 2.
